(19) United States
(12) Patent Application Publication
(10) Pub. No.: US 2015/0067139 A1
(43) Pub. Date: Mar. 5, 2015

(54) AGENTLESS MONITORING OF COMPUTER SYSTEMS

(71) Applicant: James R. Malnati, Stillwater, MN (US)

(72) Inventor: James R. Malnati, Stillwater, MN (US)

(73) Assignee: Unisys Corporation, Blue Bell, PA (US)

(21) Appl. No.: 14/011,828

(22) Filed: Aug. 28, 2013

(51) Int. Cl. H04L 12/26

(52) U.S. Cl. CPC H04L 43/04
USPC 709/224

(57) ABSTRACT

An agentless monitor may monitor a remote server through a communication session. The monitor may transmit commands for execution on the remote server by a simulated user. Results from the executed commands may be returned to the agentless monitor for parsing and execution of logical rules. The agentless monitor may be used, for example, to identify and terminate looping processes executing on the remote server before failure or performance degradation of the remote server.

### FIELD OF THE DISCLOSURE

The instant disclosure relates to computer networks. More specifically, this disclosure relates to monitoring of computer systems on a computer network.

### BACKGROUND

Computer systems, and servers in particular, form an information backbone upon which companies now rely on almost exclusively for data storage, data mining, and data processing. These systems are indispensable for the improved efficiency and accuracy at processing data as compared to manual human processing. Furthermore, these systems provide services that could not be realistically accomplished by human processing. For example, some computer systems execute physical simulations in hours that would otherwise take decades to complete by human computations. As another example, some computer systems store terabytes of data and provide instantaneous access to any of the data, which may include records spanning decades of company operations.

Monitoring these computers systems is a top priority for their operators and administrators to ensure that the computer systems are continuously available without interruption. Conventionally, a system operator, or often a team of shift workers, with knowledge of the computer system to be monitored, establish a network-based communication session into the target computer system. A person with this expertise level could submit system status commands, examine the results, and take actions based on the returned data. This is a highly manual and expensive approach to system monitoring, as a paid employee must be constantly deployed to sustain 24-hour vigilance. This manual method does not scale well, as few individuals may monitor more than a handful of systems without suffering productivity degradation. Thus, there is a need for improved monitoring of computer systems.

### SUMMARY

Computer systems, such as servers, may be agentlessly monitored through a script engine executed on a client computer system remote from the servers. The computer system may execute a different operating system than the operating system executing on the server. The agentless monitor may communicate with the server, issue scripts for execution on the server, parse results received from the server, and detect and/or correct conditions on the server that may lead to a failure.

Agentless monitoring may be programmed once and deployed to any number of systems. The monitoring may continue 24 hours a day, 7 days a week, 365 days a year and after the initial implementation costs no more to deploy widely than when used to monitor a single system. The agentless monitoring sequence may be easily adapted as systems change by changing the set of scripted commands on the agentless monitor, rather than installing updates to the server. Unlike agents that consume memory, CPU, and disk space in their monitoring efforts, agentless monitoring is achieved at the cost of only a single additional (simulated) user on the target system. Commands submitted are those implemented by the primary system vendor, so customized programs need not be written and maintained. This further reduces monitoring cost and leads to a robust solution that may be evolved over time as needs change. Automated, agentless monitoring has very low impact (footprint) on the system as commands are submitted and the results examined.

One example of the general agentless monitoring concept described above includes detection of looping processes. Looping processes may occur on computer systems and be detected through execution of Tandem Advanced Command Language (TACL) commands to monitor process priorities. A looping program may be dealt with by an operating system by lowering the timesharing priority of the looping process over time. An agentless monitor may periodically send a TACL command to list the priority of all processes. The returned processes' names and states may be stored in a variable group member along with the initial priority. Over time, if the priority changes in accordance with specific criteria, an administrator may be notified by, for example, text message. If nothing is done to correct the situation manually and the reduced priority crosses a specified threshold, the agentless monitor may terminate the program and raise an appropriate alert and/or send another text message.

According to one embodiment, a method may include initiating, by an agentless monitor, a communication session with a remote computer. The method may also include transmitting, by the agentless monitor, scripted commands through the communication session for execution on the remote computer. The method may further include receiving, by the agentless monitor, a result of execution of the transmitted scripted commands. The method may also include executing, by the agentless monitor, a logical rule based, at least in part, on the received result.

According to another embodiment, a computer program product having non-transitory computer readable medium. The medium may include code to perform the step of initiating, by an agentless monitor, a communication session with a remote computer. The medium may also include code to perform the step of transmitting, by the agentless monitor, scripted commands through the communication session for execution on the remote computer. The method may further include code to perform the step of receiving, by the agentless monitor, a result of execution of the transmitted scripted commands. The medium may also include code to perform the step of executing, by the agentless monitor, a logical rule based, at least in part, on the received result.

According to yet another embodiment, an apparatus includes a memory and a processor coupled to the memory. The processor may be configured to execute the step of initiating, by an agentless monitor, a communication session with a remote computer. The processor may also be configured to execute the step of transmitting, by the agentless monitor, scripted commands through the communication session for execution on the remote computer. The processor may further be configured to perform the step of receiving, by the agentless monitor, a result of execution of the transmitted scripted commands. The processor may also be configured to perform the step of executing, by the agentless monitor, a logical rule based, at least in part, on the received result.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating a method of agentless monitoring according to one embodiment of the disclosure.

FIG. 2 is a call diagram illustrating agentless monitoring according to one embodiment of the disclosure.

FIG. 3 is a flow chart illustrating another method of agentless monitoring according to one embodiment.

FIG. 4 is a block diagram illustrating a computer network according to one embodiment of the disclosure.

FIG. 5 is a block diagram illustrating a computer system according to embodiment of the disclosure.

### DETAILED DESCRIPTION

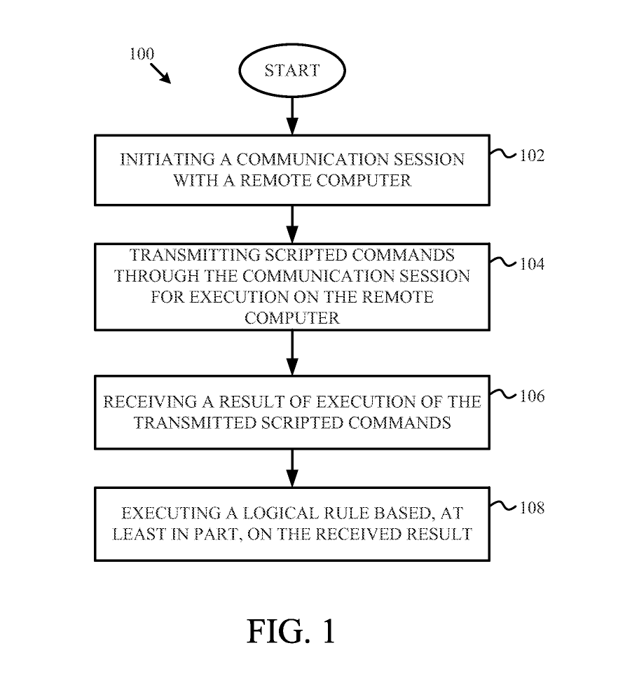

FIG. 1 is a flow chart illustrating a method of agentless monitoring according to one embodiment of the disclosure. A method begins at block 102 with the agentless monitor initiating a communication session with a remote computer, such as a server. The communication session may be, for example, either a Telnet session, a Secure Shell (SSH) session, or asynchronous connection. At block 104, the agentless monitor transmits scripted commands through the communication session for execution on the remote computer. The scripted commands may include Tandem OS commands written in the Tandem Advanced Command Language (TACL). The remote computer may then execute the scripted commands through a user account on the remote computer and generate results. No agent software may be necessary on the remote computer. At block 106, a result of the execution of the scripted commands is received by the agentless monitor from the remote server over the communication session.

At block 108, a logical rule may be executed by the agentless monitor based, at least in part, on the received result at block 106. The logical rule may specify an action, including at least one of transmitting additional scripted commands through the communication session for execution on the remote computer, handling an alert, transmitting messages to support, and/or logging data.

In one embodiment, the method 100 of FIG. 1 may be customized for detecting looping processes executing on the remote computer. The transmitted scripted commands may include a command for listing running processes on the remote computer along with an associated priority for each of the running processes. The agentless monitor may identify a looping process by determining when at least one running process of the listed running processes receives a decrease in priority over time. The logical rule executed at block 108 may then include terminating the identified looping program.

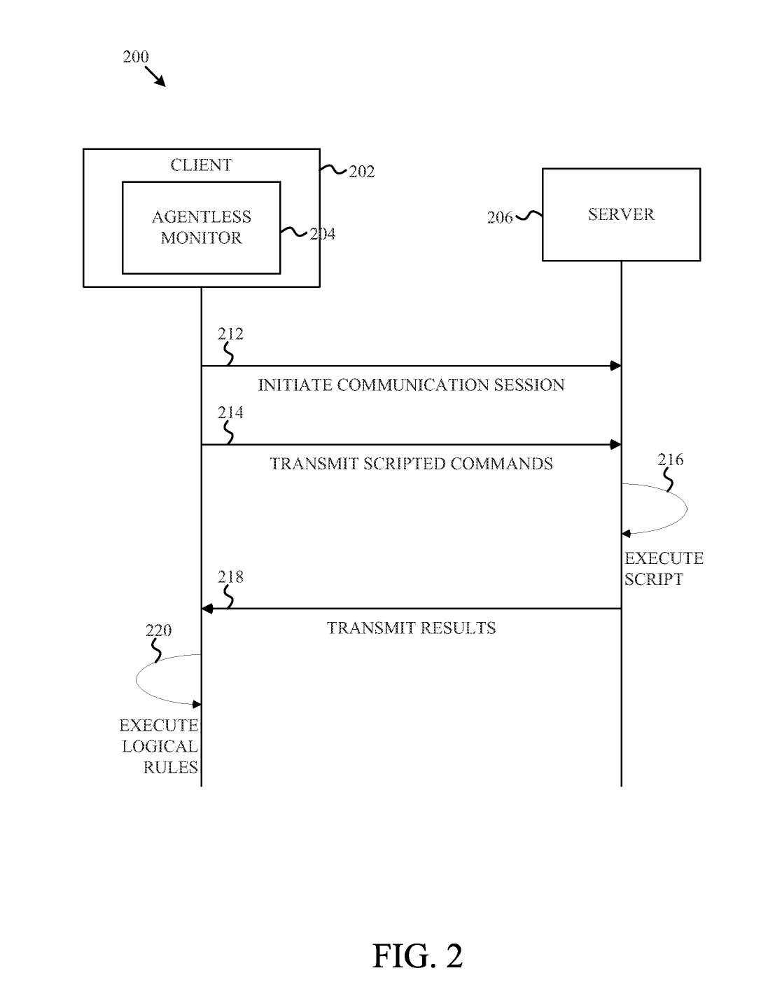

FIG. 2 is a call diagram illustrating agentless monitoring according to one embodiment of the disclosure. An agentless monitor 204 may execute on a client 202. The client 202 may host a number of agentless monitors, such as by executing each agentless monitor in a hosted environment. The agentless monitor may initiate a communication session with a server 206 at call 212. At call 214, scripted commands are transmitted to the server 206. The scripted commands may be selected from sets of scripted commands programmed into the agentless monitor and set to execute at specific times or specific intervals based, at least in part, on the computer name or computer type of the server 206. At call 216, the server 206 executes the scripted commands. The scripted commands may be executed, for example, through a simulated user on the server 206. Executing through a simulated user allows the scripted commands to be executed on the server 206 without any additional software loaded on the server 206. At call 218, results from the scripted commands are transmitted from the server 206 to the agentless monitor 204. The agentless monitor 204 may execute logical rules against the results at call 220.

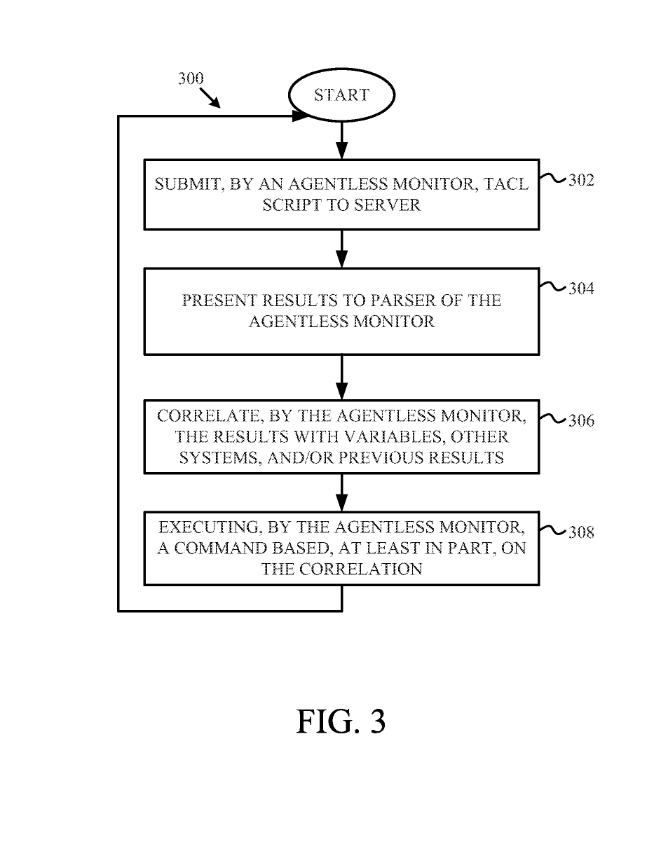

FIG. 3 is a flow chart illustrating another method of agentless monitoring according to one embodiment. A method 300 begins at block 302 by submitting, from an agentless monitor, a TACL script to a server. The script may be executed at the server and results returned to the agentless monitor. At block 304, results may be parsed by the agentless monitor. At block 306, the agentless monitor may correlate the results of block 304 with variables, other systems, and/or previous results. At block 308, the agentless monitor may execute a command based, at least in part, on the correlation.

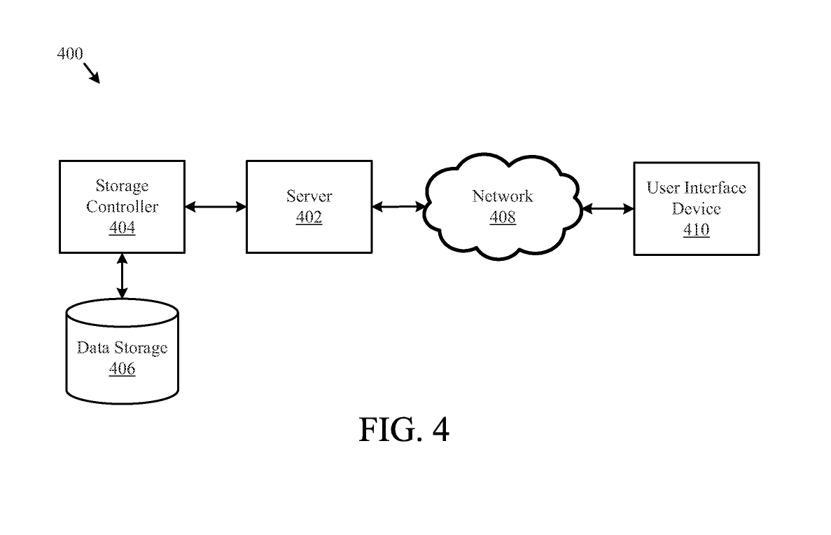

FIG. 4 illustrates one embodiment of a system 400 for an information system, including a system for agentless monitoring. The system 400 may include a server 402, a data storage device 406, a network 408, and a user interface device 410. In a further embodiment, the system 400 may include a storage controller 404, or storage server configured to manage data communications between the data storage device 406 and the server 402 or other components in communication with the network 408. In an alternative embodiment, the storage controller 404 may be coupled to the network 408.

In one embodiment, the user interface device 410 is referred to broadly and is intended to encompass a suitable processor-based device such as a desktop computer, a laptop computer, a personal digital assistant (PDA) or tablet computer, a smartphone, or other mobile communication device having access to the network 408. In a further embodiment, the user interface device 410 may access the Internet or other wide area or local area network to access a web application or web service hosted by the server 402 and may provide a user interface for specifying data for remote monitoring of results obtained by the agentless monitor.

The network 408 may facilitate communications of data between the server 402 and the user interface device 410. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

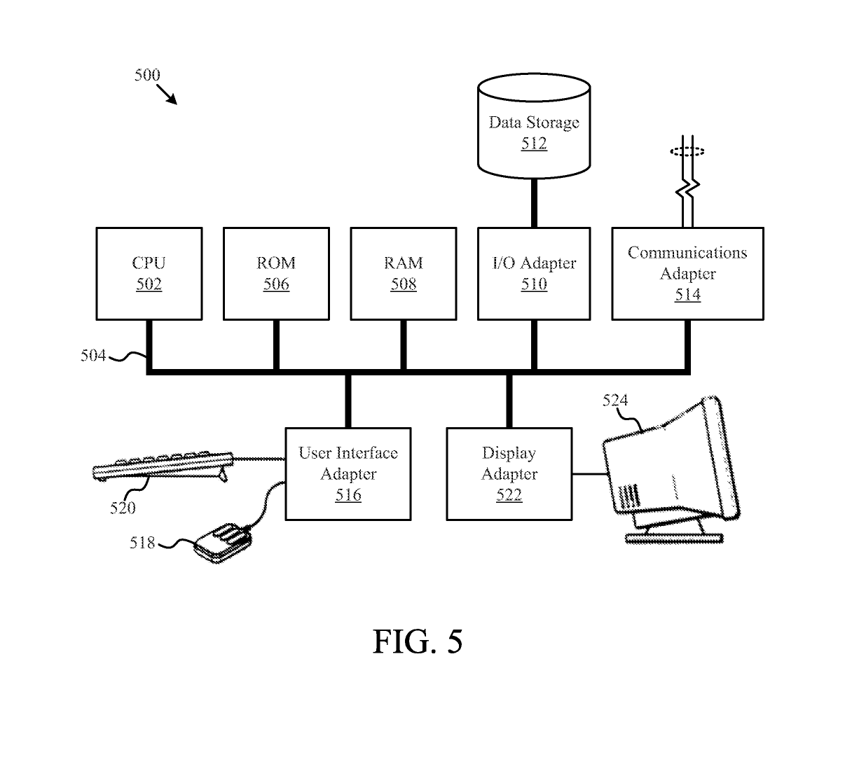

FIG. 5 illustrates a computer system 500 adapted according to certain embodiments of the server 402 and/or the user interface device 410. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 may also include random access memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data, and both the RAM 508 and the ROM 506 may be randomly accessed.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to the network 408, which may be one or more of a LAN, WAN, and/or the Internet. The user interface adapter 516 couples user input devices, such as a keyboard 520, a pointing device 518, and/or a touch screen (not shown) to the computer system 500. The keyboard 520 may be an on-screen keyboard displayed on a touch panel. The display adapter 522 may be driven by the CPU 502 to control the display on the display device 524. Any of the devices 502-522 may be physical and/or logical.

The applications of the present disclosure are not limited to the architecture of computer system 500. Rather the computer system 500 is provided as an example of one type of computing device that may be adapted to perform the functions of the server 402 and/or the user interface device 410. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 600 may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
initiating, by an agentless monitor, a communication session with a remote computer;
transmitting, by the agentless monitor, scripted commands through the communication session for execution on the remote computer;
receiving, by the agentless monitor, a result of execution of the transmitted scripted commands; and
executing, by the agentless monitor, a logical rule based, at least in part, on the received result.

2. The method of claim 1, in which the communication session comprises at least one of a telnet session, a secure shell (SSH) connection, and an asynchronous connection.

3. The method of claim 1, in which the scripted commands comprise Tandem OS commands and the remote computer comprises a Tandem server.

4. The method of claim 1, in which the logical rule comprises performing, based at least on the received result, at least one of:
transmitting additional scripted commands through the communication session for execution on the remote computer;
handling an alert;
transmitting messages to support; and
logging data.

5. The method of claim 1, in which the transmitted scripted command comprises a command for listing running processes on the remote computer along with an associated priority for each of the running processes.

6. The method of claim 5, in which the logical rule comprises identifying a looping process by determining when at least one running process of the listed running processes receives a decrease in priority over time.

7. The method of claim 6, in which the logical rule further comprises terminating the identified looping process.

8. A computer program product, comprising:
a non-transitory computer-readable medium comprising code to perform the steps of:
initiating, by an agentless monitor, a communication session with a remote computer;
transmitting, by the agentless monitor, scripted commands through the communication session for execution on the remote computer;
receiving, by the agentless monitor, a result of execution of the transmitted scripted commands; and
executing, by the agentless monitor, a logical rule based, at least in part, on the received result.

9. The computer program product of claim 8, in which the communication session comprises at least one of a telnet session, a secure shell (SSH) connection, and an asynchronous connection.

10. The computer program product of claim 8, in which the scripted commands comprise Tandem OS commands and the remote computer comprises a Tandem server.

11. The computer program product of claim 8, in which the logical rule comprises performing, based at least on the received result, at least one of:
transmitting additional scripted commands through the communication session for execution on the remote computer;
handling an alert;
transmitting messages to support; and
logging data.

12. The computer program product of claim 8, in which the transmitted scripted command comprises a command for listing running processes on the remote computer along with an associated priority for each of the running processes.

13. The computer program product of claim 12, in which the logical rule comprises identifying a looping process by determining when at least one running process of the listed running processes receives a decrease in priority over time.

14. The computer program product of claim 13, in which the logical rule further comprises terminating the identified looping process.

15. An apparatus, comprising:
a memory; and
a processor coupled to the memory, in which the processor is configured to perform the steps of:
initiating, by an agentless monitor, a communication session with a remote computer;
transmitting, by the agentless monitor, scripted commands through the communication session for execution on the remote computer;
receiving, by the agentless monitor, a result of execution of the transmitted scripted commands; and
executing, by the agentless monitor, a logical rule based, at least in part, on the received result.

16. The apparatus of claim 15, in which the communication session comprises at least one of a telnet session, a secure shell (SSH) connection, and an asynchronous connection.

17. The apparatus of claim 15, in which the logical rule comprises performing, based at least on the received result, at least one of:
transmitting additional scripted commands through the communication session for execution on the remote computer;
handling an alert;
transmitting messages to support; and
logging data.

18. The apparatus of claim 15, in which the transmitted scripted command comprises a command for listing running processes on the remote computer along with an associated priority for each of the running processes.

19. The apparatus of claim 18, in which the logical rule comprises identifying a looping process by determining when at least one running process of the listed running processes receives a decrease in priority over time.

20. The apparatus of claim 19, in which the logical rule further comprises terminating the identified looping process.
